(19) United States
(12) Patent Application Publication
(10) Pub. No.: US 2023/0367796 A1
(43) Pub. Date: Nov. 16, 2023

(54) Narrative Feedback Generator

(71) Applicant: Brian Leon Woods, Winnetka, CA (US)

(72) Inventor: Brian Leon Woods, Winnetka, CA (US)

(73) Assignee: Brian Leon Woods, Winnetka, CA (US)

(21) Appl. No.: 17/742,678

(22) Filed: May 12, 2022

(51) Int. Cl. G06F 16/332; G06F 16/33; G06F 40/30; G06F 40/253; G06F 40/279

(52) U.S. Cl. CPC G06F 16/3326; G06F 16/3329; G06F 16/3344; G06F 40/30; G06F 40/253; G06F 40/279

(57) ABSTRACT

Some embodiments provide narrative feedback generator that assists a user in composing narrative feedback paragraphs. In one embodiment, a method stores sentences associated with a plurality of performance levels and with one of a plurality of feedback element tiers and links sentences between different tiers. The method also receives a selection of an output document type and an individual of the output document. The method then filters for a first set of sentences associated with a first tier in the hierarchy and presents the first set of sentences to the user and receives a selection of a first sentence in the first set of sentences. Additionally, the method filters for a second set of sentences that are associated both with a second tier in the hierarchy and linked to the first sentence and presenting the second set of sentences to the user and receives a selection of a second sentence in the second set of sentences. The method then generates a paragraph comprising the first and second sentences.

### FIELD OF THE INVENTION

The present disclosure relates generally to narrative feedback generators, and more particularly to methods, programs, and systems that enable users to generate narrative essays from previously inputted sentences.

### BACKGROUND

In learning environments, sharing observations of student actions and behaviors is the cornerstone of feedback. Beyond mere evaluations, good feedback should describe student decisions, behaviors and actions as well as the significance of them. Feedback should also include next steps to help the learner reach the next level. One problem with prior art programs is the lack of ability to integrate multiple feedback elements. For example, the drawbacks of other programs are they:
(1) Only offer evaluation comments, thus omitting feedback elements such as: supporting details, impact sentences and next steps. This compels teachers to manually type or copy/paste information from a different source. Thus, other programs force users to spend more time than necessary to complete composing narratives.
(2) Overlook supporting details as a discrete feedback element (i.e., observable behaviors). Therefore, other programs are ill-equipped to specifically address formative feedback.
(3) Lack specificity, allowing users to store any type of feedback element in the same field. Without the ability to discretely store different feedback elements, information must be contained in larger “buckets”. Therefore, the inefficiency of storing data forces users to unnecessarily wade through dozens of completely unrelated comments.

Good writing relies on a bona fide paragraph structure to ensure a logical train of thought. A classic paragraph format is the inverted pyramid: topic sentence, supporting information and a conclusion. Since other programs rely almost exclusively on evaluations— or topic sentences—there is no real paragraph structure. Furthermore, feedback will either be superficial or teachers must to type their ideas or copy/paste text from another source to overcome this shortcoming. These additional steps undermine any time-saving benefits other programs offer.

### BRIEF DESCRIPTION OF THE DRAWINGS

FIG. 1 illustrates a conceptual overview of different stages of the narrative feedback generator according to some embodiments.

FIG. 2 shows a conceptual overview of example hierarchical relationships of different feedback sentence elements and performance levels that may be used by the narrative feedback generator according to some embodiments.

FIG. 3 shows a conceptual illustration of an exemplary database of the narrative feedback generator according to some embodiments.

FIG. 4 shows a user performing an exemplary feedback sentence input process according to some embodiments.

FIG. 5 shows a user performing an exemplary feedback sentence linking process according to some embodiments.

FIG. 6 shows the narrative feedback generator filtering for evaluation topic sentences and a user selecting one of the evaluation topic sentences in an exemplary process, according to some embodiments.

FIG. 7 shows the narrative feedback generator filtering for supporting details sentences and the user selecting one of the supporting detail sentences in an exemplary process, according to some embodiments.

FIG. 8 shows the narrative feedback generator filtering for impact sentences and the user selecting one of the impact sentences in an exemplary process, according to some embodiments.

FIG. 9 shows the narrative feedback generator filtering for next step conclusion sentences and the user selecting one of the next step conclusion sentences in an exemplary process, according to some embodiments.

FIG. 10 shows a paragraph generation module of the narrative feedback generator generating a feedback paragraph from selected feedback sentences, according to some embodiments.

FIGS. 11A-B show exemplary feedback sentence input interfaces of the narrative feedback generator, according to some embodiments.

FIG. 12 shows an exemplary feedback sentence linking interface of the narrative feedback generator, according to some embodiments.

FIGS. 13A-B show exemplary feedback sentence selection interfaces, according to some embodiments.

FIGS. 13A-B show exemplary feedback sentence selection interfaces, according to some embodiments.

FIG. 14 shows an exemplary output document having two feedback paragraphs generated by the narrative feedback generator, according to some embodiments.

FIG. 15 shows an overall flow of a method performed by the narrative feedback generator, according to some embodiments.

### SUMMARY

Some embodiments provide a narrative feedback generator that assists a user in composing narrative feedback paragraphs. In one embodiment, a method stores sentences associated with a plurality of performance levels and with one of a plurality of feedback element tiers and links sentences between different tiers. The method also receives a selection of an output document type and an individual of the output document. The method then filters for a first set of sentences associated with a first tier in the hierarchy and presents the first set of sentences to the user and receives a selection of a first sentence in the first set of sentences. Additionally, the method filters for a second set of sentences that are associated both with a second tier in the hierarchy and linked to the first sentence and presenting the second set of sentences to the user and receives a selection of a second sentence in the second set of sentences. The method then generates a paragraph comprising the first and second sentences.

The following detailed description and accompanying drawings provide a better understanding of the nature and advantages of various embodiments of the present disclosure.

### DETAILED DESCRIPTION

In the following description, for purposes of explanation, numerous examples and specific details are set forth in order to provide a thorough understanding of the present disclosure. It will be evident, however, to one skilled in the art that various embodiments of the present disclosure as defined by the claims may include some or all of the features in these examples alone or in combination with other features described below, and may further include modifications and equivalents of the features and concepts described herein.

By and large, comment generators have been designed to generate K-12 narrative reports. As distance learning becomes more ubiquitous, the need for improved feedback tools will increasingly gain importance. There is, however, a need for narrative feedback beyond school environments. Unlike many competitors, Feedback Genie can be tweaked to be used in any environment in which narrative feedback or evaluation is needed. FBG can generate narratives for non-academic settings, including but not limited to: corporate performance reviews, annual assisted living reports, social service assessments, letters of recommendation, department of correction documentation, real estate appraisals, high-end collectible appraisals, and more. For non-academic settings, FBG guides users in terms of which feedback elements should be used for certain occasions. Since other programs rely almost exclusively on evaluation sentences—or topic sentences—there is no real paragraph structure. In cases such as this, feedback will either be superficial or teachers must to type their ideas or copy/paste text from another source to overcome this shortcoming. These additional steps undermine any time-saving benefits other programs offer.

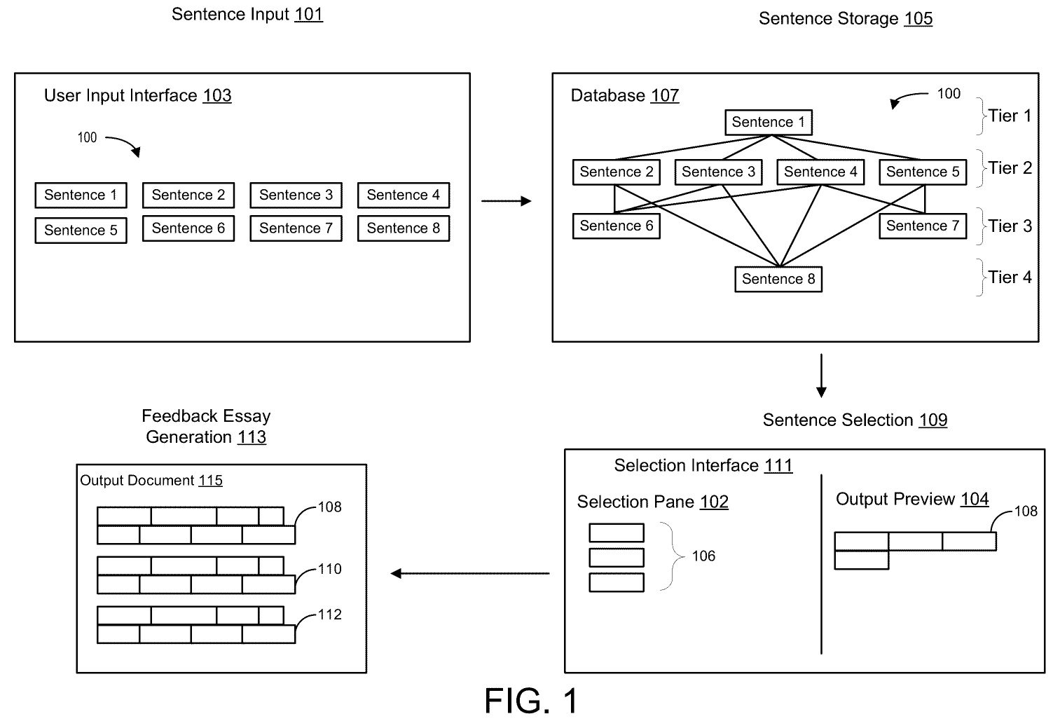

FIG. 1 illustrates a conceptual overview of different stages of the narrative feedback generator according to some embodiments. In these embodiments, the narrative feedback generator is shown to traverse four stages: sentence input 101, sentence storage 105, sentence selection 109, and essay generation 113. In the sentence input 101 stage, the narrative feedback generator presents to a user a user input interface 103 in which the user can input sentences that they wish to use in future narrative essay writing. In the student evaluation context, a teacher may wish to input sentences that describe student performance that the teacher foresees a need for. For example, the teacher may input sentences that they believe they will use when writing feedback on the students, such as in assignment feedback and end-of-term report cards. Here, the user inputs a plurality of feedback sentences 100.

The plurality of sentences 100 may include sentences associated with different tiers in a compositional hierarchy, for example topic sentences, supporting details, impact sentences, and conclusions sentences, etc. Further, the user may use the user input interface 103 to specify the tier within the compositional hierarchy with which each inputted sentence is associated. Additionally, the input interface 103 allows the user to specify links between sentences that are conceptually related or that logically flow from one another. Here, user specifies that sentence 1 is a topic sentence, sentences 2-5 are supporting details, sentences 6-7 are impact sentences, and sentence 8 is a conclusion sentence. While not shown, the user also links various sentences to each other that the user believes flow together.

The feedback generator next proceeds to the sentence storage 105 stage in which the feedback generator stores the plurality of sentences 100 in database 107. More specifically, the narrative feedback generator is configured to store feedback sentences in database 107 according to their respective tiers. Further, the narrative feedback generator is also configured to links between feedback sentences in database 107. As shown, sentence 1 is stored at tier 1 (corresponding to topic sentences), sentences 2-5 are stored at tier 2 (corresponding to supporting details), sentences 6-7 are stored at tier 3 (corresponding to impact sentences), and sentence 8 is stored at tier 4 (corresponding to conclusion sentences). Also, links between the plurality of sentences 100 are stored. In the example shown, sentence 1 in tier 1 is linked to sentences 2-5 in tier 2, which in turn are linked to sentences 6-7 in tier 3 and to sentence 8 in tier 4. This example reflects an observation of the one-to-many relationship between topic sentences and supporting details, the one-to-many relationship between supporting details and impact sentences, as well as the many-to-one relationship between supporting details and conclusion sentences. That is, one topic sentence may logically and narratively flow into many supporting details and the many supporting details may logically and narratively lead to a conclusion sentence.

Next, the narrative feedback generator proceeds to the sentence selection 109 stage in which the user selects stored feedback sentences to generate feedback essays. More particularly, the user may use the selection interface 111 to select sentences previously inputted and stored to build a feedback essay. In the example of a student evaluations, the teacher may select the feedback sentences they wish to include in a student's assignment feedback or end-of-term report card. As shown, the selection interface 111 includes a selection pane 102 that displays a plurality of feedback sentences 106. As the user selects feedback sentences (e.g., by clicking or dragging and dropping), the output preview 104 previews to the user a feedback paragraph 108 comprising the selected sentences. In the example of student evaluations, the selection interface 111 may allow the user to select a particular student, a particular subject or course, a particular semester or period, a particular type of output document, among other parameters.

The narrative feedback generator then proceeds to a feedback essay generation 113 stage in which the narrative feedback generator generates an output document 115 comprising feedback paragraphs built by the user. In the context of student evaluations, the output document 115 may include a feedback essay addressed to parents of the student or to the student themselves describing the student's performance. Here, the output document 115 that is generated includes feedback paragraphs 108-112, each of which has a plurality of feedback sentences selected by the user.

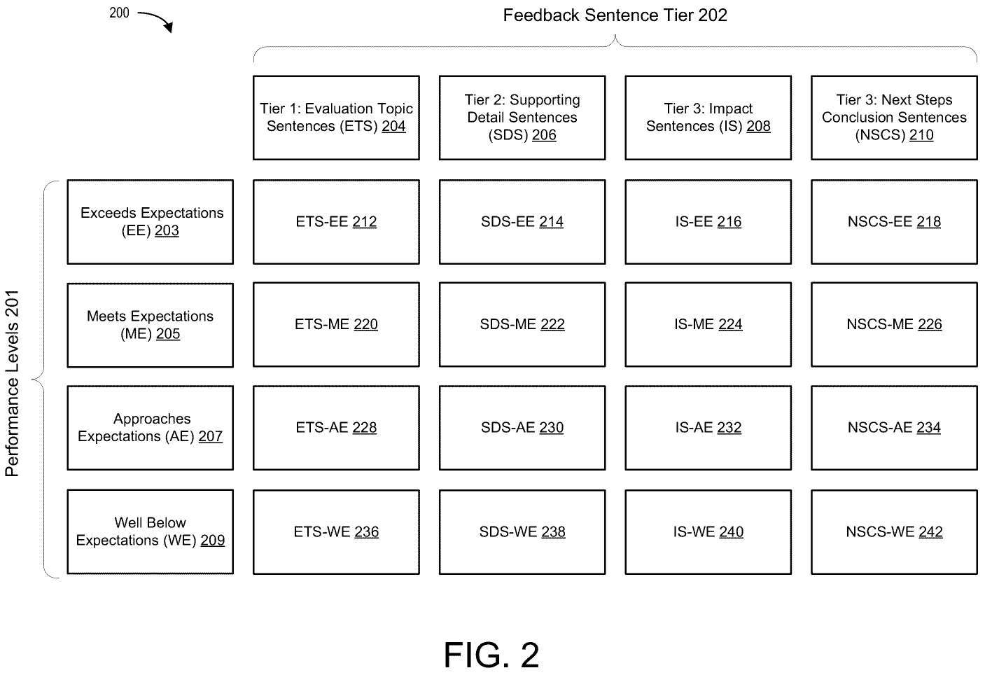

FIG. 2 shows a conceptual overview of example hierarchical relationships of different feedback sentence tiers 202 and performance levels 201 that may be used by the narrative feedback generator according to some embodiments. In some embodiments, feedback sentence tiers 202 and performance levels 201 are attributes of feedback sentences. That is, each feedback sentence has a feedback sentence tier 202 attribute and a performance level 201 attribute. As shown, the feedback sentence tiers 202 and the performance levels 201, together, form matrix 200 with different tiers of feedback sentence tiers 202 as columns in matrix 200 and with different performance levels 201 as rows in matrix 200. As shown, feedback tiers 202 include evaluation topic sentences (ETS) 204, supporting detail sentences (SDS) 206, impact sentences (IS) 208, next steps conclusion sentences (NSCS) 210.

Feedback sentence tiers 202 correspond to the logical structure of paragraph writing in the English language: the inverted pyramid format. Here, ETS 204 may correspond to topic sentences or the first sentence in paragraph. NSCS 210 may correspond to conclusion sentences or the last sentence in a paragraph. SDS 206 and IS 208 may correspond to intervening sentences that support the topic sentence such as examples, details, and the like.

Performance levels 201 include exceeds expectations (EE) 203, meets expectations (ME) 205, approaches expectations (AE) 207, well below expectations (WE) 209. These performance levels 201 correspond to typical grading or evaluations schemes in the learning context.

Matrix 200 shows each of the possible attribute combinations 212-242 that the narrative feedback generator uses to store feedback sentences. In other words, feedback generator stores each inputted feedback sentence with a feedback sentence tier 202 attribute and a performance level 201 attribute. This granular storing scheme enables the narrative feedback generator to efficiently filter for relevant feedback sentences in downstream selection processes.

Although FIG. 2 shows four tiers of feedback sentence tiers 202 and four performance levels 201, FIG. 2 is intended to be an example and the present disclosure is not limited to a specific number of feedback sentence tiers 202 nor performance levels 201.

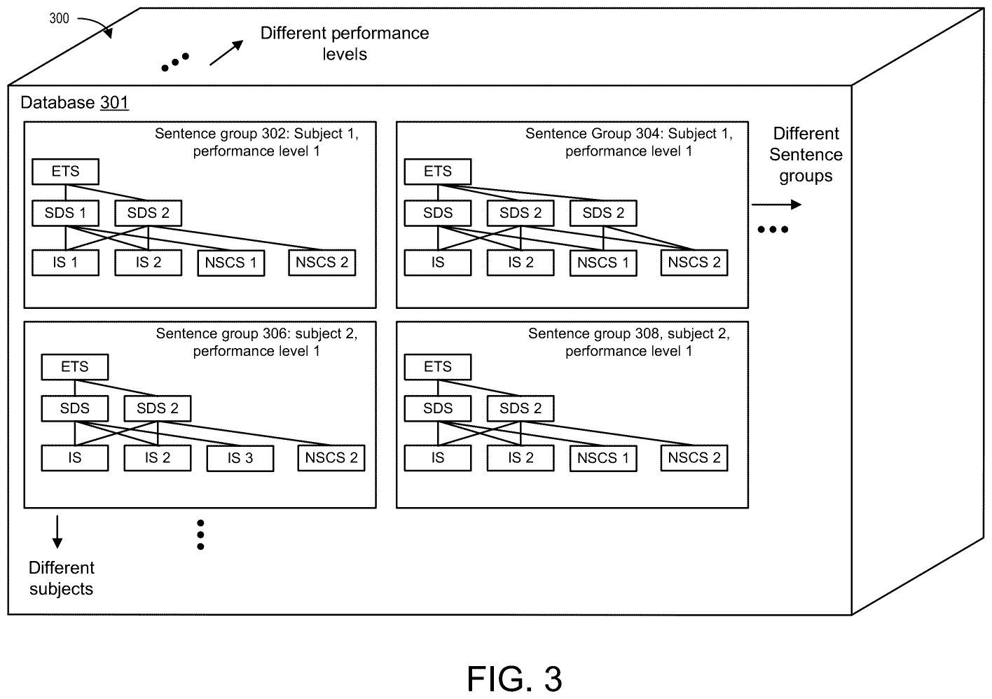

FIG. 3 shows a conceptual illustration of an exemplary data structure 300 in database 301 of the narrative feedback generator according to some embodiments. Data structure 300 has a first dimension corresponding to different feedback sentence groups, a second dimensions corresponding to different subjects, and a third dimension corresponding to different performance levels. A sentence group is the universe or pool of logically and topically related sentences from which a feedback paragraph is composed. In the student evaluation context, a sentence group may include the universe of sentences the teacher may need to form a performance evaluation paragraph on the student for a particular topic, objective, or subject. Each sentence group in database 301 is associated with a particular subject (e.g., Algebra 2, AP U.S. History, Chemistry Honors, etc.) and a particular performance level (e.g., exceeds expectations, meets expectations, approaches expectations, and well below expectations, etc.). Further, within each sentence group, each feedback sentence is associated or linked with at least one other feedback sentence in the group. In this way, database 301 enables downstream selection processes to be carried out efficiently.

In the example of FIG. 3, sentence group 302-304 are associated with subject 1 and performance level 1 while sentence groups 306-308 are associated with subject 2 and performance level 1. Sentence groups associated with performance levels other than performance level 1 are not shown for clarity, but they would appear “behind” sentence groups 302-308. Focusing on sentence group 302, seven individual sentences are shown to be part of sentence group 302: an evaluation topic sentence, two supporting detail sentences, two impact sentences, and two next step conclusions sentences. It should be noted that while the next step conclusion sentences are linked to the supporting detail sentences in the example shown, in other embodiments, next step conclusion sentences may be linked to impact sentences or to evaluation topic sentences.

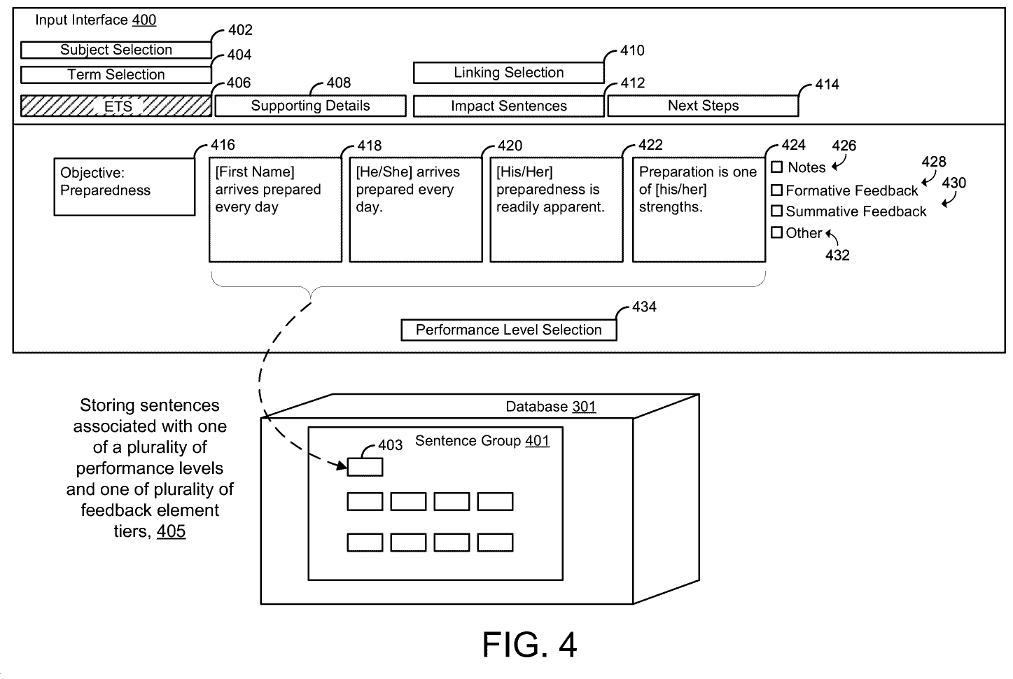

FIG. 4 shows a user performing an exemplary feedback sentence input process for creating sentence groups according to some embodiments. At this stage, the user inputs the sentences they believe they will need in the future when generating feedback paragraphs. In the student evaluation context, a teacher may use input interface 400 to input the sentences they believe they need to form performance evaluations (e.g., report cards, assignment feedback, and the like) over the course of the semester or quarter. Once inputted, the teacher can quickly use the inputted sentence to build performance evaluations without having to retype each sentence.

Input interface 400 includes subject selection 402, performance level selection 434, term selection 404, linking selection 410, and selection buttons for evaluation topic sentences (ETS) 406, supporting detail sentences (SDS) 408, impact sentences (IS) 412, and next step conclusion sentences (NSCS) 414. Subject selection 402 may enable the user to select a subject attribute of the inputted sentences. For example, in the student evaluation context, if the evaluator (e.g., teacher) intends to input feedback sentences related to home room, or social studies, or geometry, they may make a corresponding selection in subject selection 402. Once selected, the narrative feedback generator associates the inputted sentence with the subject selected in subject selection 402.

Performance level selection 434 may enable the user to select a performance level attribute of inputted sentences. Once selected, the narrative feedback generator associates the inputted sentences with the performance level attribute selected in performance level selection 434. Linking selection 410 may enable the user to link inputted feedback sentences with one another from different tiers of feedback elements. Once linked by the user, the narrative feedback generator associates the selected feedback sentences with one another. Selection buttons for evaluation topic sentences (ETS) 406, supporting detail sentences (SDS) 408, impact sentences (IS) 412, and next step conclusion sentences (NSCS) 414 enable the user to select which feedback sentence tier they are to input sentences for. In other words, the user would select ETS 406 if they intend input evaluation topic sentences, SDS 408 if they intend to input supporting detail sentences, IS 412 if they intend to enter impact sentences, and NSCS 414 if they intend to input next step conclusion sentences. Here, the user has selected ETS 406.

Also shown in input interface 400 are an objective field 416, sentence fields 418-424, and output document selection boxes 426-432. Objective field 416 enables the user to select an objective the inputted sentences are directed to. For a given subject, the user may wish to address a number of objectives in their evaluation pertaining to the subject. For example, given the subject of Art, the user may have a number of objectives associated with that subject, such as preparedness, stays on task, asks relevant questions, applying concepts, keen insights, etc. Here, the user has inputted “preparedness” into objective field 416.

In the embodiment shown, sentence fields 418-424 are where the user inputs the sentences that they want to store into the narrative feedback generator for later retrieval. The four distinct fields enable the user to vary the sentence without varying its meaning. This variation in sentence composition improves the readability of feedback paragraphs. In the example shown, the user may use sentence fields 418-424 to vary the pronoun used to start sentences. In the example shown, the sentence fields 418-424 come pre-populated with different pronoun variations to prompt the user to create four sentences using different pronoun variations. In this manner, the feedback paragraph product can be created to flow better for the reader. Here, the user inputs feedback sentences with pronoun variations in each of the sentence fields 418-424.

Also shown in FIG. 4 are the inputted feedback sentences being stored in sentence group 401 in database 103. For example, the narrative feedback generator is shown to store sentences (associated with one of a plurality of performance levels (the performance selected using performance level selection 434) and one of a plurality of feedback sentence tiers (the feedback sentence tier of evaluation topic sentences) 405. As shown, the inputted feedback sentences are stored at data element 403 at the first tier of sentence group 401 because the inputted sentences are associated with ETS 406. In this example, data element 403 represents the content (e.g., the words) that was inputted in each of sentence fields 418-424.

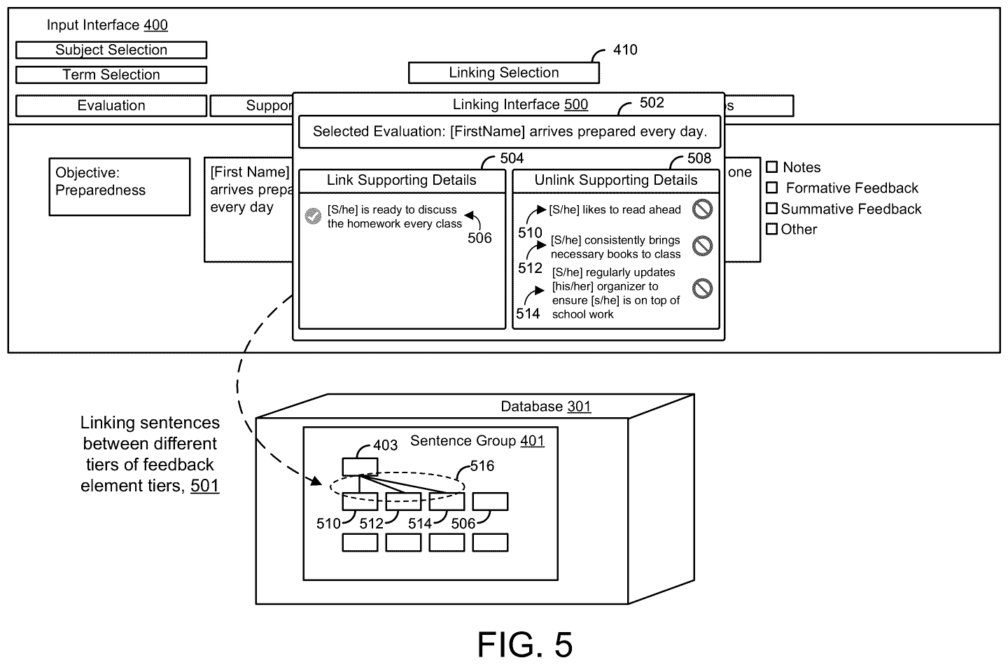

FIG. 5 shows a user performing an exemplary feedback sentence linking process for linking sentences together according to some embodiments. Linking sentences refers to the ability to logically link sentences that would naturally go together in a sequence. For example, a topic sentence and a supporting detail may naturally go together in a sequence when composing a paragraph. Linking defines the logical relationships between sentences in database 301 of the narrative feedback generator. In the previous example, once the topic sentence and supporting details are linked, the supporting detail may be automatically retrieved for the user when the topic sentence that the supporting detail is linked to is selected.

In FIG. 5, the user may have clicked on linking selection 410 to link supporting detail sentences with the evaluation topic sentence of “[FirstName] arrives prepared every day.” In response, input interface 400 displays linking interface 500, which includes areas 502, 504, and 508. Area 502 displays the selected sentence for which linking will occur. Here, that selected sentence is “[FirstName] arrives prepared every day.” Database depicts that selected sentence as sentence 403, which is a first-tier sentence in sentence group 401. Area 504 displays sentences that have not yet been linked to the selected sentence. Here, that unlinked sentence is sentence 506. Area 508 displays sentences that have been linked to the selected sentence. Here, those sentences are sentences 510-514.

In response to the user selecting sentences 510, 512, and 514 in linking interface 500, the narrative feedback generator links sentences between different tiers of feedback elements 501 (e.g., between evaluation topic sentence 403 and supporting detail sentences 510, 512, and 514). After such linking, sentences 510-514 are shown to have links 516 to sentence 403. No such link is shown between sentence 403 and sentence 506. The user may continue to use linking interface 500 to establish all desired links between stored sentences.

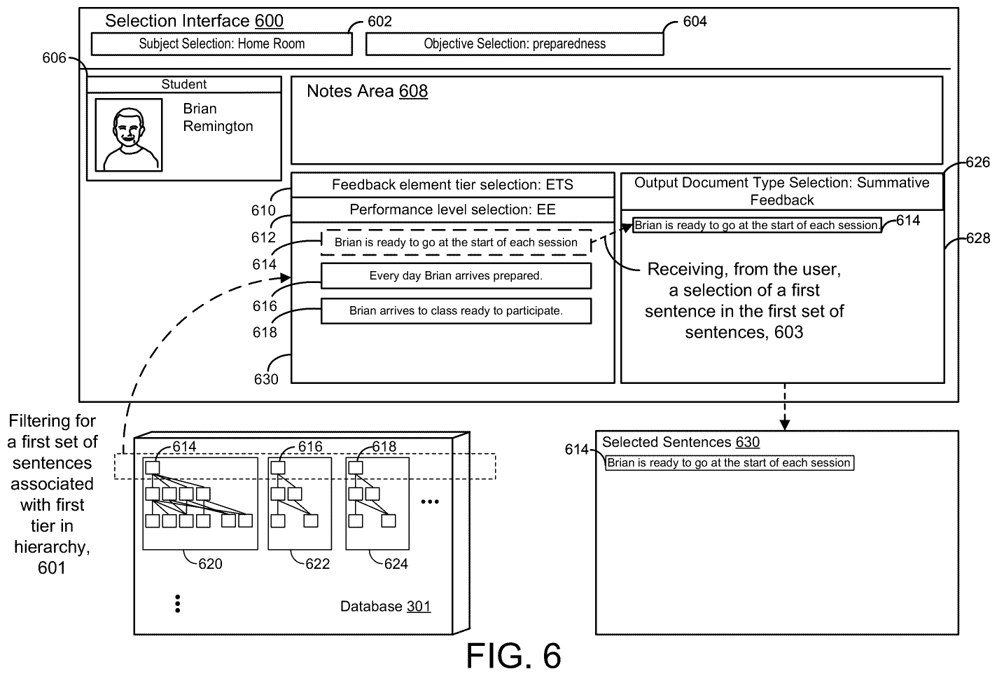

FIG. 6 shows a selection interface 600 of the narrative feedback generator filtering for evaluation topic sentences and a user selecting one of the evaluation topic sentences in an exemplary process, according to some embodiments. Selection interface 600 is shown to include a subject selection 602, and objective selection 604, an individual selection 606, a notes area 608, a selection pane 630, and an output preview 628. In the example shown, the user uses subject selection 602 and objective selection 604 to select a subject and objective of the feedback paragraph they will compose, respectively. In some embodiments, a subject may correspond to a course or class taught by the user while the objective may correspond to a goal or area of focus within that course or class. Here, the user selects “Home Room” for subject selection 602 and “Preparedness” for the objective selection 604.

In the embodiment shown, individual selection 606 is where the user selects the individual for whom the feedback paragraph will be composed. Here, that individual is “Brian Remington.” Notes area 608 may include the user's notes about the particular individual the user took through the course of the semester, for example.

Selection pane 630 includes a feedback element tier selection 610, a performance level selection, and retrieved sentences 614-618. In the example shown, the user may use feedback element tier selection 610 to select the tier (e.g., evaluation topic sentences, supporting detail sentences, etc.) the user wishes to compose the feedback paragraph. Here, since the user is just beginning to compose a paragraph, they select “ETS.” In some embodiments, the available selections are previewed in output document type selection 626, which will be discussed in more detail below. Performance level selection 612 allows the user to specify a performance level for which the retrieved sentences 614-618 will be retrieved. In some embodiments, selection interface 600 may automatically select a performance level selection 612 by looking up a grade associated with individual 606. Here, for example, selection interface 600 may have populated performance level selection 612 to “EE” by first looking up Brian's grade in class.

Output preview pane 628 includes an output document type selection 626 for the user to selection a type of output document they wish to generate. Some examples of output documents types include: summative feedback, formative feedback, and teacher notes. Summative feedback has a hierarchy of feedback element tiers comprising evaluation topic sentences, supporting details, impact sentence, or next steps; formative feedback has a hierarchy of feedback element tiers comprising supporting details, impact sentences, or next steps; and teacher notes has a hierarchy of feedback element tiers comprising supporting details or next steps. In some embodiments, the narrative feedback generator automatically selects feedback tier selection 610 based on the output document type selection 626. Here, summative feedback is selected. As a result, narrative feedback generator automatically selects ETS as the feedback element tier selection 610. Selected sentences 630 stores the sentences selected by the user to compose a feedback paragraph.

Next, the narrative feedback generator filters for a first set of sentences associated with a first tier in hierarchy, 601 in database 301. Here, that first tier in hierarchy is ETS. Also, the narrative feedback generator filters for sentences associated with the subject selection 602 and the performance level selection 612. According to the figure, the narrative feedback generator retrieves a first set of sentences 614-618 from sentence groups 620-624 for display in selection pane 630. Notably, the narrative feedback generator does not retrieve sentences unrelated to the user's selection. That is, the narrative feedback generator does not retrieve sentences that are not evaluation topic sentences, or sentences that are not associated with an “EE” performance level, or sentences that are not associated with the subject of “Home Room.” As shown, the user selects sentence 614 as the topic sentence in their feedback paragraph. As a result, the narrative feedback generator receives, from the user, a selection of a first sentence (sentence 614) in the first set of sentences 603. In response, the narrative feedback generator displays sentence 614 in the output preview pane 628 and adds sentence 614 to selected sentences 630.

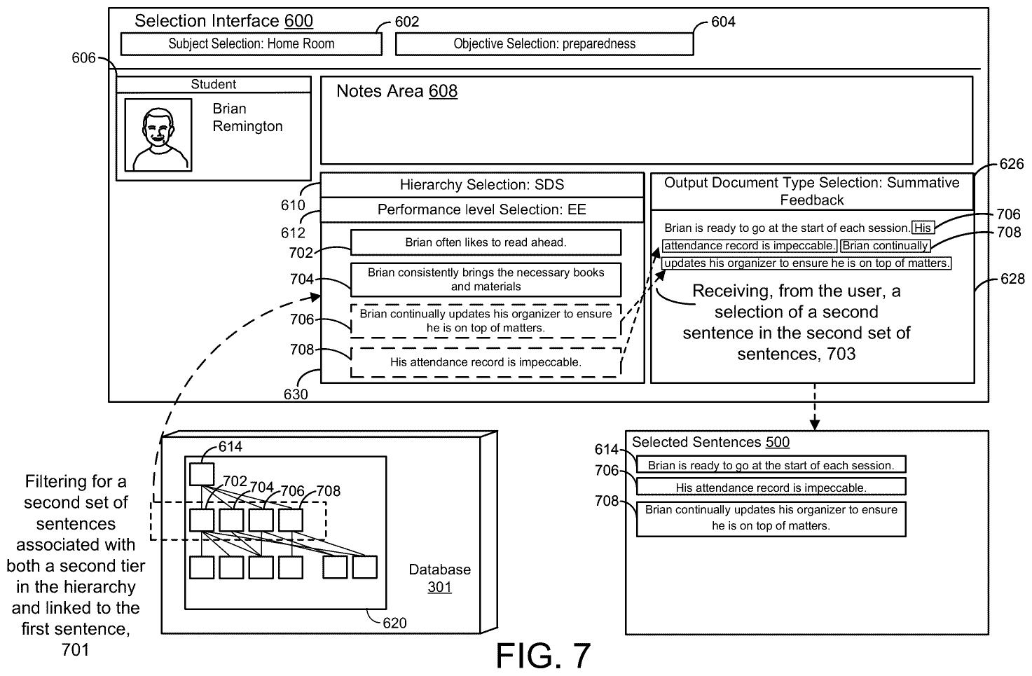

FIG. 7 shows the narrative feedback generator filtering for supporting details sentences and the user selecting one of the supporting detail sentences in an exemplary process, according to some embodiments. Specifically, the user has finished selecting an evaluation topic sentence and has now selected supporting detail sentences in hierarchy selection 610 to continue composing the feedback paragraph. In response, the narrative feedback generator filters for a second set of sentences associated with both a second tier in the hierarchy (here, supporting detail sentences) and linked to the first sentence 701 (here, linked to sentence 614 (“Brian is ready to go at the start of each session”)). The sentences that satisfy the filtering conditions are sentences 702-708, which are supporting detail sentences that are linked to sentence 614.

Sentences 702-708 are then shown to be displayed in the selection pane 630. The user is shown to have selected sentences 706-708 to use to compose the feedback paragraph. As a result, the narrative feedback generator receives, from the user, a selection of a second sentence (sentence 706) in the second set of sentences (sentences 702-704) 703. In addition to sentence 706, narrative feedback generator also receives a selection of sentence 708. Those sentences 706-708 are then shown in output preview 628. Additionally, those sentences 706-708 are included in selected sentences 500.

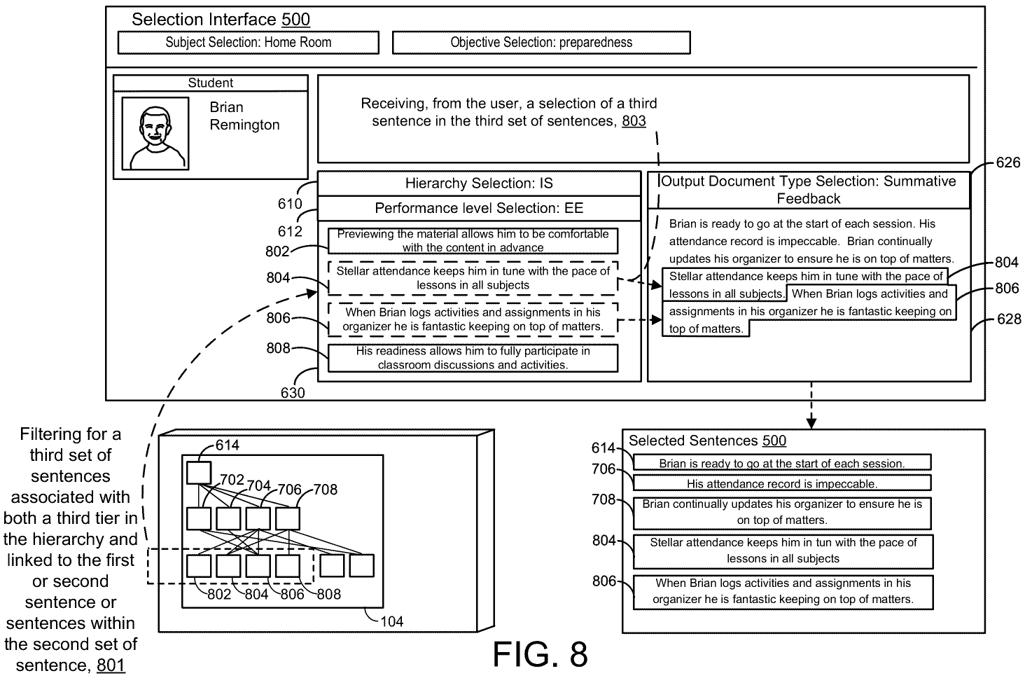

FIG. 8 shows the narrative feedback generator filtering for impact sentences and the user selecting one of the impact sentences in an exemplary process, according to some embodiments. Specifically, the user has finished selecting supporting detail sentences and is has now selected impact sentences in hierarchy selection 610 to continue composing the feedback paragraph. In response, the narrative feedback generator filters for a third set of sentences associated with both a third tier in the hierarchy (here, impact sentences) and linked to the first sentence (here, linked to sentence 614 (“Brian is ready to go at the start of each session”)) or second sentence (here, linked to sentence 706) and sentences within the second set of sentences (here, sentences 702-708). The sentences that satisfy the filtering conditions are sentences 802-808, which are impact sentences that are linked to sentence 706 and other sentences in the second set of sentences, sentences 702, 704, and 708.

Sentences 802-808 are then shown to be displayed in the selection pane 630. The user is shown to have selected sentences 804-806 to use to compose the feedback paragraph. As a result, the narrative feedback generator receives, from the user, a selection of a third sentence (sentence 804) in the third set of sentences 803 (sentences 802-808). In addition to sentence 804, narrative feedback generator also receives a selection of sentence 806. Those sentences 804-806 are then shown in output preview 628. Additionally, those sentences 804-806 are included in selected sentences 500.

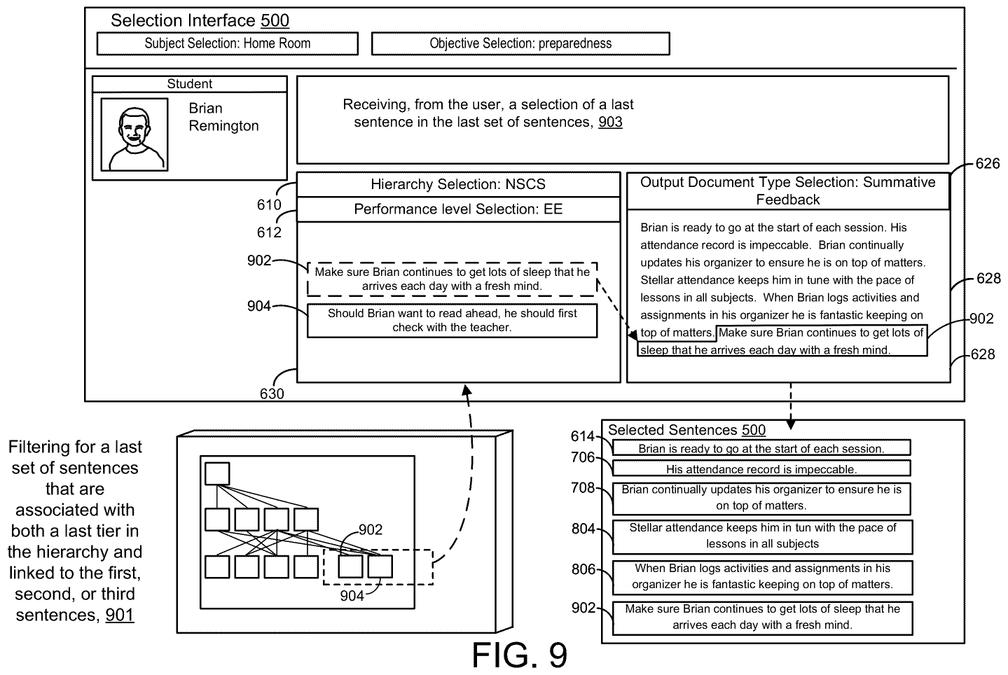

FIG. 9 shows the narrative feedback generator filtering for next step conclusion sentences and the user selecting one of the next step conclusion sentences in an exemplary process, according to some embodiments. Specifically, the user has finished selecting impact sentences and is has now selected next step conclusion sentences in hierarchy selection 610 to finish composing the feedback paragraph. In response, the narrative feedback generator filters for a last set of sentences associated with both a last tier in the hierarchy (here, next step conclusion sentences) and linked to the first, second, or third sentence (here, linked to sentence 614 (“Brian is ready to go at the start of each session”), sentence 706 (“His attendance record is impeccable”), or sentence 804 (“Stellar attendance keeps him in tune with the pace of lessons in all subjects”)). The sentences that satisfy the filtering conditions are sentences 902-904, which are next step conclusions sentences that are linked to sentence 706.

Sentences 902-904 are then shown to be displayed in the selection pane 630. The user is shown to have selected sentence 902 to use to finishing composing the feedback paragraph. As a result, the narrative feedback generator receives, from the user, a selection of a last sentence (sentence 902) in the last set of sentences 903 (sentences 902-904). As shown, sentence 902 is included in selected sentences 500.

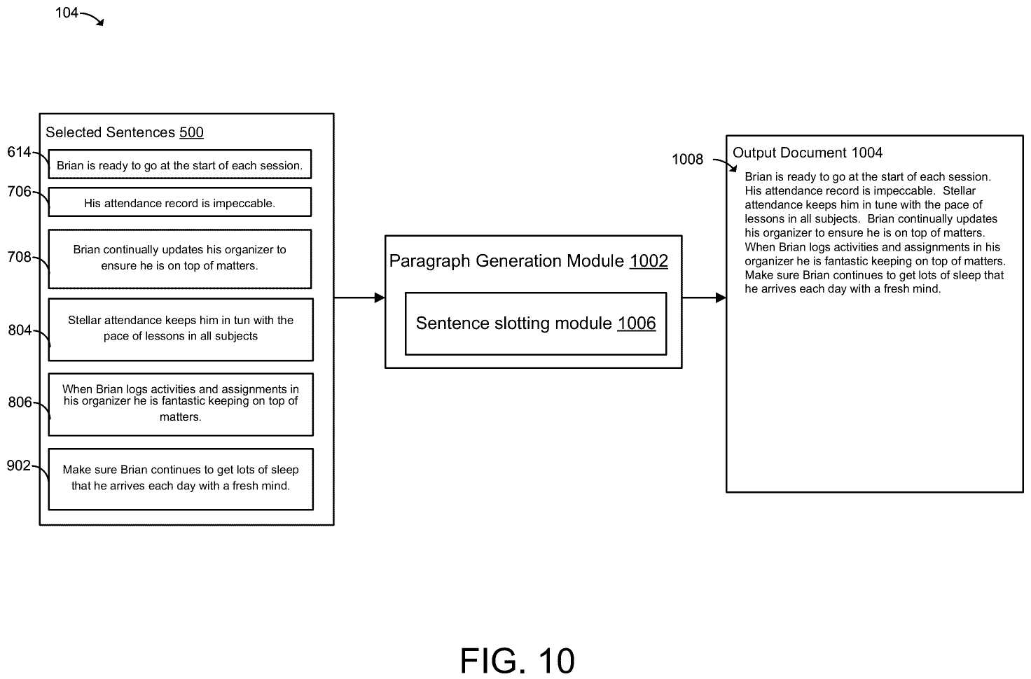

FIG. 10 shows a paragraph generation module 1002 of the narrative feedback generator generating a feedback paragraph 1008 from selected sentences 500, according to some embodiments. Paragraph generation module 1002 is responsible for generating the final feedback paragraph 1008 in output document 1004 based on predefined rules. Those rules may reflect best practices when providing feedback to students or the parents of students. Those rules may also reflect best practices in English language essay composition. In the embodiment shown, paragraph generation module 1002 includes a sentence slotting module 1006. Sentence slotting modules 1006 is responsible for slotting sentences based on the predefined rules into an order they will appear in the feedback paragraph 1008. In some instances, sentence slotting module 1006 will reorder sentences into an order that is different from the order that the sentences were received to improve the readability and flow of feedback paragraph. For example, sentence slotting module 1006 may reorder supporting detail sentences and impact sentences such that linked pairs of supporting detail sentences and impact sentences are slotted in consecutive slots rather than in inconsecutive slots. In the example shown, selected sentences 500 shows the selected sentences 614, 706, 708, 804, 806, and 902 in the order those sentences were selected temporally. However, if this order were used, the supporting detail sentences and the linked impact sentences would not be consecutively slotted. Instead, two supporting detail sentences would be consecutively slotted and two impact sentences would be consecutively slotted, leading to an unnaturally sounding feedback paragraph. Here, sentence slotting module 1006 reorders selected sentences 614, 706, 708, 804, 806, and 902 such that sentences 706 and 804, which both deal with attendance, to be slotted consecutively, and sentences 708 and 806, which both deal with organizer use, to be slotted consecutively in feedback paragraph 1008. Finally, the narrative feedback generator user may then send output document 1004 to the intended reader, which is Brian's parents or guardians in the embodiment shown.

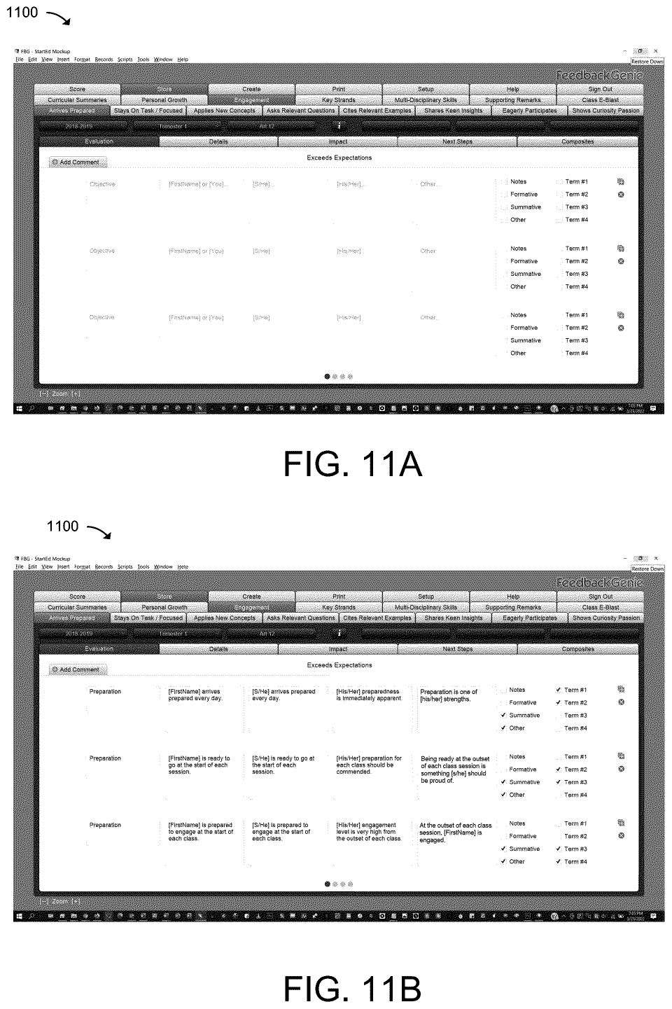

FIGS. 11A-B show exemplary feedback sentence input interfaces 1100 of the narrative feedback generator, according to some embodiments. FIG. 11A shows the input interface 1100 without having been filled with feedback sentences. As shown, different fields going from left to right have pronoun “hints” in them to suggest which pronoun the user should use when inputting various sentences. In FIG. 11B, the user has inputted feedback sentences into input interface 1100 according to the pronoun hints. As shown, the user has inputted three evaluation topic sentences associated with a subject of “engagement” and a performance level of “exceeds expectations.” To the right of the inputted sentences, the user has used an array of checkboxes to select which output documents and terms they wish to employ the inputted sentences.

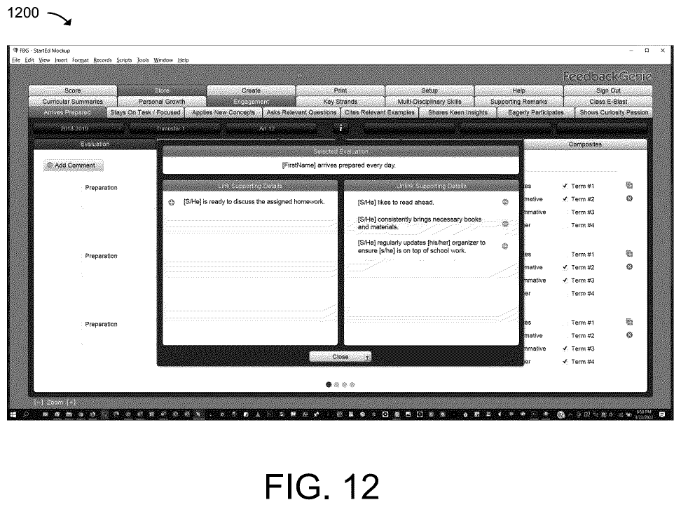

FIG. 12 show an exemplary feedback sentence linking interface 1200 of the narrative feedback generator, according to some embodiments. As shown, the user is using linking interface 1200 to link a selected evaluation sentence “[FirstName] arrives prepared every day” with supporting detail sentences. So far, the user has linked three supporting detail sentences to the selected evaluation sentences.

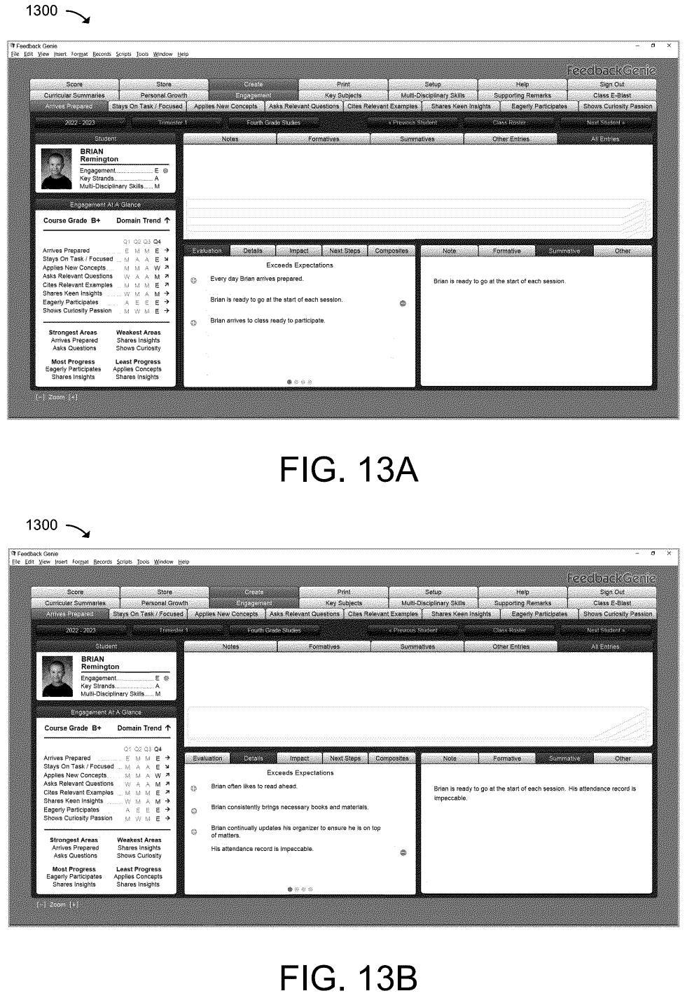

FIGS. 13A-B show exemplary feedback sentence selection interfaces 1300, according to some embodiments. As shown, the user has just begun composing a feedback paragraph for student Brian Remington for the subject of “Engagement.” To assist the user with composing this feedback paragraph, the selection interface 1300 displays a notes section above the selection section that would contain the teacher's notes about Brian Remington throughout the term. The selection interface also displays an “engagement at a glance” portion with a summary of Brian's performance related to several objectives.

Selection interface 1300 shows three evaluation topic sentences. Notably, all of these sentences are associated with a performance level of exceeds expectations. This may be because selection interface 1300 auto-navigated to this performance level based on the narrative feedback generator's knowledge of Brian's grade in class. For example, the narrative feedback generator may first look up Brian's associated grade in class and auto-navigate to sentences with a performance level that matches Brian's grade. Here, the user selects one evaluation topic sentence.

FIG. 13B shows the selection interface 1300 displaying supporting detail sentences that are linked to the evaluation topic sentences. Here, the user selects a supporting detail sentence in composing the feedback paragraph.

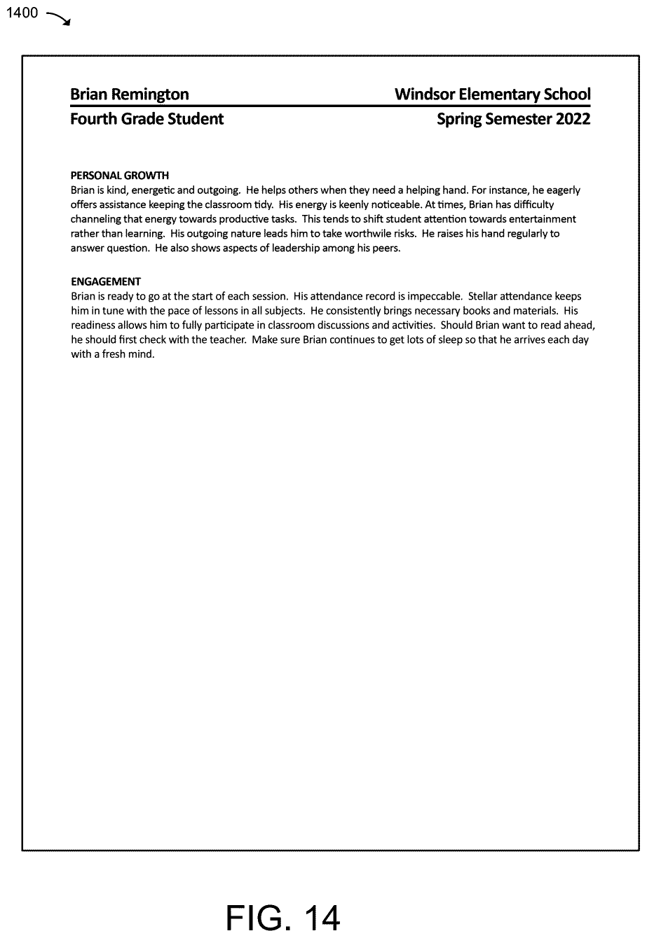

FIG. 14 shows an exemplary output document 1400 having two feedback paragraphs generated by the narrative feedback generator, according to some embodiments. In some embodiments such as the one shown, the output document is a report card. As shown, the selected feedback sentences are arranged in feedback paragraphs that follow an inverted pyramid scheme with topic sentences and conclusions sentence bookending the paragraph and details in the middle.

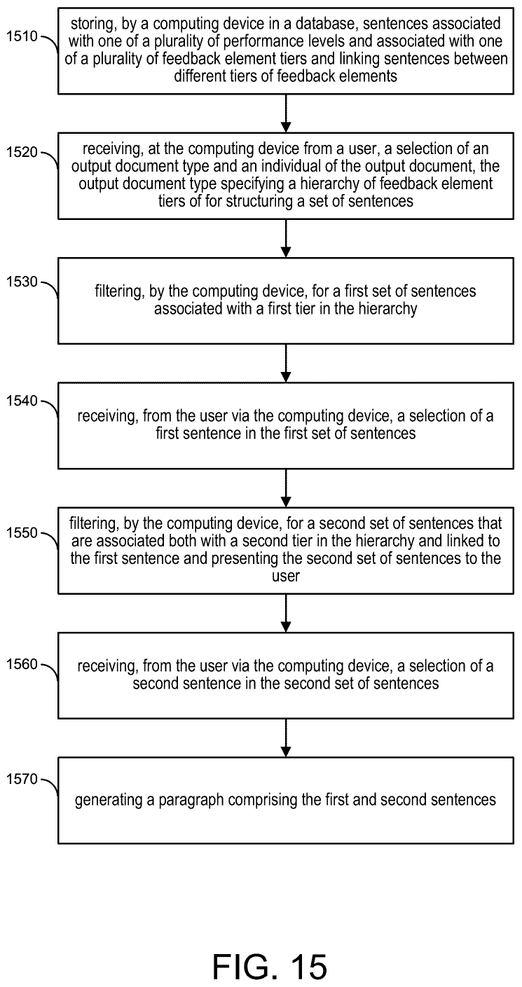

FIG. 15 shows an overall flow of a method performed by the narrative feedback generator, according to some embodiments. At 1510, the method stores sentences associated with one of a plurality of performance levels and associated with one of a plurality of feedback element tiers (e.g., ETS, SDS, IS, and NSCS) and linking at least a portion of sentences between different tiers of feedback elements (e.g., linking an ETS sentence with an SDS sentence). At 1520, the method receives a selection of an output document type (e.g., summative feedback, formative feedback, or teacher notes) and an individual of the output document (e.g., a student), the output document type specifying a hierarchy of tiers of for structuring a set of sentences. In some examples, the output document type specifies what the hierarchy of feedback element tiers are. For example, summative feedback may include a hierarchy of feedback element tiers of ETS, SDS, IS, and NSCS, formative feedback may include SDS, IS, and NSCS and teacher notes may include SDS and NSCS.

At 1530, the method filters for a first set of sentences associated with a first tier in the hierarchy (e.g., ETS) and presenting the first set of sentences to the user. At 1540, the method receives a selection of a first sentence in the first set of sentences (e.g., a particular ETS sentence). At 1550, the method filters for a second set of sentences that are associated both with a second tier (e.g., SDS) in the hierarchy and linked to the first sentence (e.g., linked that the ETS sentence the user selected) and presenting the second set of sentences to the user. At 1560, the method receives a selection of a second sentence (e.g., a particular SDS sentence) in the second set of sentences. Further, at 1570, the method generates a paragraph comprising the first and second sentences (e.g., the ETS sentence and the SDS sentence.

The above description illustrates various embodiments of the present disclosure along with examples of how aspects of the present disclosure may be implemented. The above examples and embodiments should not be deemed to be the only embodiments, and are presented to illustrate the flexibility and advantages of various embodiments of the present disclosure as defined by the following claims. Based on the above disclosure and the following claims, other arrangements, embodiments, implementations and equivalents will be evident to those skilled in the art and may be employed without departing from the spirit and scope of the present disclosure as defined by the claims.

What is claimed is:

1. A method comprising:
storing, by a computing device in a database, sentences associated with one of a plurality of performance levels and associated with one of a plurality of feedback element tiers and linking sentences between different tiers of feedback element tiers;
receiving, at the computing device from a user, a selection of an output document type and an individual of the output document, the output document type specifying a hierarchy of feedback element tiers of for structuring a set of sentences;
filtering, by the computing device, for a first set of sentences associated with a first tier in the hierarchy and presenting the first set of sentences to the user;
receiving, from the user via the computing device, a selection of a first sentence in the first set of sentences;
filtering, by the computing device, for a second set of sentences that are associated both with a second tier in the hierarchy and linked to the first sentence and presenting the second set of sentences to the user;
receiving, from the user via the computing device, a selection of a second sentence in the second set of sentences; and
generating a paragraph comprising the first and second sentences.

2. The method of claim 1, further comprising:
filtering, by the computing device, for a third set of sentences including sentences that are both associated with a third tier in the hierarchy and linked to the first or second sentences and sentences within the second set of sentences and displaying the third set of sentences to the user; and
receiving, from the user via the computing device, a selection of a third sentence from the third set of sentences;
wherein the paragraph comprises the first, second, and third sentences.

3. The method of claim 1, further comprising:
filtering, by the computing device, a last set of sentences that are associated with both a last tier in the hierarchy and linked to the first, second, or third sentences and presenting the last set of sentences to the user; and
receiving, from the user via the computing device, a selection of a last sentence from the last set of sentences;
wherein the paragraph comprises the first, second, third, and last sentences.

4. The method of claim 3, wherein the first sentence is an evaluation topic sentence, the second sentence is a supporting detail sentence, the third sentence is a supporting detail sentence or impact sentence, and the last sentence is a next steps conclusion sentence.

5. The method of claim 1, wherein the first sentence is a supporting detail sentence and the second sentence is an impact sentence.

6. The method of claim 1, wherein the feedback element tiers include evaluation topic sentences, supporting details, impact sentences, and next steps conclusion sentences.

7. The method of claim 1, wherein output document types include summative feedback, formative feedback, and teacher notes,
wherein summative feedback has a hierarchy of feedback element tiers comprising evaluation topic sentences, supporting details, impact sentence, or next steps,
wherein formative feedback has a hierarchy of feedback element tiers comprising supporting details, impact sentences, or next steps, and
wherein teacher notes has a hierarchy of feedback element tiers comprising supporting details or next steps.

8. The method of claim 1, wherein the performance levels include exceeds expectations, meets expectations, approaches expectations, and well below expectations, the method further comprising:
looking up a performance level associated with the selected individual.

9. The method of claim 1, further comprising:
presenting an input interface for the user to input sentences and link sentences between different tiers of feedback element tiers; and
receiving, at the computing device from the user, a plurality of sentences belonging to different tiers of feedback element tiers.

10. The method of claim 8, further comprising:
linking sentences in different tiers of feedback element tiers, such that when the user selects the first sentence, only sentences that are linked by the user to the first sentence are displayed.

11. The method of claim 8, wherein the input interface enables the user to associate one or more sentences with one or more output document types such that the one or more sentences are presented to the user only when the associated one or more output document types are selected.

12. The method of claim 1, further comprising:
cleansing, at the computing device prior to said storing, sentences inputted by the user by:
removing punctuation errors inputted by the user;
removing additional spaces inputted by the user;
highlighting for the user inputted words that are classified as negative, jargon or hyperbole; and
identifying for the user entries that extend beyond a predefined word count.

13. The method of claim 2, wherein the method receives more than one selection from the second and third sets of sentences, the method further comprising:
receiving, from the user via the computing device after said filtering for the second set of sentences, a selection of a fourth sentence along with the selection of the second sentence in the second set of sentences, the second and fourth sentences being supporting detail sentences;
receiving, from the user via the computing device after said filtering for the third set of sentences, a selection of a fifth sentence along with the selection of the third sentence, the third and fifth sentence being impact sentences;
wherein an order of receiving selections of sentences is: the first sentence, the second sentence, the fourth sentence, the third sentence, and the fifth sentence.

14. The method of claim 13, wherein generating the paragraph comprises:
slotting the first sentence in a first slot;
slotting the second sentence in a second slot;
slotting the third sentence in a third slot;
slotting the fourth sentence in a fourth slot;
slotting the fifth sentence in a fifth slot;
ordering the received sentence based on a slot order and not receipt order,
wherein an order of the received sentences in the generated paragraph is: the first sentence, the second sentence, the third sentence, the fourth sentence, and the fifth sentence.

15. The method of claim 1, wherein said filtering for the first set of sentences includes filtering for sentences that are also associated with a performance level of the individual.

16. A non-transitory machine-readable medium storing a program executable by at least one processing unit of a device, the program comprising sets of instructions for:
storing, by a computing device in a database, sentences associated with one of a plurality of performance levels and associated with one of a plurality of feedback element tiers and linking sentences between different tiers of feedback element tiers;
receiving, at the computing device from a user, a selection of an output document type and a individual of the output document, the output document type specifying a hierarchy of feedback element tiers of for structuring a set of sentences;
filtering, by the computing device, for a first set of sentences associated with a first tier in the hierarchy;
receiving, from the user via the computing device, a selection of a first sentence in the first set of sentences;
filtering, by the computing device, for a second set of sentences that are associated both with a second tier in the hierarchy and linked to the first sentence and presenting the second set of sentences to the user;
receiving, from the user via the computing device, a selection of a second sentence in the second set of sentences; and
generating a paragraph comprising the first and second sentences.

17. The non-transitory machine-readable medium of claim 16, wherein the program further comprises instructions for:
filtering, by the computing device, for a third set of sentences including sentences that are both associated with a third tier in the hierarchy and linked to the first or second sentences and sentences within the second set of sentences and displaying the third set of sentences to the user; and
receiving, from the user via the computing device, a selection of a third sentence from the third set of sentences;
wherein the paragraph comprises the first, second, and third sentences.

18. The non-transitory machine-readable medium of claim 17, wherein the program further comprises instructions for:
filtering, by the computing device, a last set of sentences that are associated with both a last tier in the hierarchy and linked to the first, second, or third sentences and presenting the last set of sentences to the user; and
receiving, from the user via the computing device, a selection of a last sentence from the last set of sentences;
wherein the paragraph comprises the first, second, third, and last sentences.

19. A system comprising:
a set of processing units; and
a non-transitory machine-readable medium storing instructions that when executed by at least one processing unit in the set of processing units cause the at least one processing unit to:
store, by a computing device in a database, sentences associated with one of a plurality of performance levels and associated with one of a plurality of feedback element tiers and linking sentences between different tiers of feedback element tiers;
receive, at the computing device from a user, a selection of an output document type and a individual of the output document, the output document type specifying a hierarchy of feedback element tiers of for structuring a set of sentences;
filter, by the computing device, for a first set of sentences associated with a first tier in the hierarchy;
receive, from the user via the computing device, a selection of a first sentence in the first set of sentences;
filter, by the computing device, for a second set of sentences that are associated both with a second tier in the hierarchy and linked to the first sentence and presenting the second set of sentences to the user;
receive, from the user via the computing device, a selection of a second sentence in the second set of sentences; and
generate a paragraph comprising the first and second sentences.

20. The system of claim 19, wherein the instructions further cause the at least one processing unit to:
filter, by the computing device, for a third set of sentences including sentences that are both associated with a third tier in the hierarchy and linked to the first or second sentences and sentences within the second set of sentences and displaying the third set of sentences to the user; and
receive, from the user via the computing device, a selection of a third sentence from the third set of sentences;
wherein the paragraph comprises the first, second, and third sentences.
